(19) United States
(12) Patent Application Publication
(10) Pub. No.: US 2025/0055823 A1
(43) Pub. Date: Feb. 13, 2025

(54) AUTOMATIC RANKING AND DISPLAY OF USER GROUPS IN A MESSAGING SYSTEM

(71) Applicant: Snap Inc., Santa Monica, CA (US)

(72) Inventors: Isabelle Albi, Los Angeles, CA (US); Daniel Moreno Cuellar, New York, NY (US); David Phillip Taitz, Los Angeles, CA (US); Jeremy Baker Voss, Los Angeles, CA (US); Xingnan Xia, Bellevue, CA (US)

(21) Appl. No.: 18/796,947

(22) Filed: Aug. 7, 2024

Related U.S. Application Data
(60) Provisional application No. 63/531,109, filed on Aug. 7, 2023.

(51) Int. Cl. H04L 51/216

(52) U.S. Cl. CPC H04L 51/216

(57) ABSTRACT

A method and system for identifying and displaying a messaging application user's top groups based on their activity levels are disclosed. The messaging application tracks messaging interactions initiated by a user to multiple user groups over a predetermined time period. The application assigns a score to each group based on attributes of the interactions such as type, frequency, and recency. The groups are ranked based on the scores, and a subset of top scoring groups is selected. These top groups are displayed in the messaging interface in a dedicated region, allowing quick access to recent highly-engaged groups. The top groups may be displayed alongside individual contacts identified as best friends. Users can customize graphical icons associated with each top group. The techniques rely on observed user interaction patterns to identify meaningful top groups specific to each user.

### CROSS-REFERENCE TO RELATED APPLICATION

This patent application claims the benefit of priority to U.S. Application Ser. No. 63/531,109, filed Aug. 7, 2023, which is incorporated by reference herein in its entirety.

### BACKGROUND

Messaging applications on mobile devices and computers allow users to communicate with each other via text, photo, video and other multimedia messages. Some messaging applications also allow users to create groups for sending messages to multiple recipients.

As users interact with more groups over time, existing messaging applications face challenges in terms of displaying recent conversations and user-designated priority groups. Recent conversations require users to manually search through their history to find active groups. Priority groups require extra effort from users to manually designate their favorite groups.

There is a need for messaging applications to more intelligently manage the display of users' frequent conversation groups, without requiring excessive manual effort from users. More streamlined and automated approaches to tracking user messaging activity and surfacing their most active groups could improve the user experience. The present disclosure provides technical solutions to address these challenges in messaging applications.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular clement or act, the most significant digit or digits in a reference number refer to the figure number in which that element is first introduced. Some embodiments are illustrated by way of example, and not limitation, in the figures of the accompanying drawings in which:

FIG. 1 is a diagrammatic representation of a networked environment in which the present disclosure may be deployed, in accordance with some examples.

FIG. 2 is a diagrammatic representation of a messaging system, in accordance with some examples, that has both client-side and server-side functionality.

FIG. 3 is a flowchart depicting a method for providing an interface to display user groups, in accordance with one embodiment.

FIG. 4 is an interface diagram depicting an interface to display user groups, in accordance with one embodiment.

FIG. 5 is an interface diagram depicting an interface to display user groups, in accordance with one embodiment.

FIG. 6 is an interface diagram depicting an interface to select one or more graphical icons, in accordance with one embodiment.

FIG. 7 is a diagrammatic representation of a machine in the form of a computer system within which a set of instructions may be executed for causing the machine to perform any one or more of the methodologies discussed herein, in accordance with some examples.

FIG. 8 is a block diagram showing a software architecture within which examples may be implemented.

FIG. 9 is a diagrammatic representation of a processing environment, in accordance with some examples.

### DETAILED DESCRIPTION

The present invention relates to systems and methods for prioritizing messaging groups in a messaging application, based on a user's messaging activity.

According to certain embodiments, the method involves tracking messaging interactions initiated by a user to various groups over a predetermined time period. The interactions can include sent images, sent chat messages, sent videos, or other multimedia messages.

In some embodiments, the system may perform operations that include assigning a score to each group based on the tracked messaging interactions. For example, this may involve assigning numerical values to each interaction based on attributes like the type of interaction, with different weights for photos, chats, videos, etc. The numerical values are summed over the time period to generate a score for each group among a plurality of user groups in which the user is engaged.

A subset of groups may be selected based on the assigned scores. In some embodiments, this may include ranking the groups by score and selecting the top scoring groups. The number of groups identified for display may be limited to only a top portion.

The selected top groups are displayed in an interface element of the messaging application, such as a dedicated region for “Top Groups.” The groups may be displayed with graphical icons that indicate their status as top groups. Users can customize the icon for a top group by providing inputs to select and assign a graphical icon to the “Top Groups” region. In some embodiments, the system displays the top groups in a section above the list of recent conversations and below the list of favorite contacts.

The top groups are determined and displayed automatically based on the user's own activity, requiring no manual configuration. The algorithms for scoring and selecting groups are based on weighted parameters for different interaction types and frequencies over a time period. This provides users with easy access to their most engaged groups without additional effort.

By prioritizing the most active messaging groups in the interface, users can quickly identify and access their most relevant conversations. The scores are continually updated over time to reflect changes in messaging behavior. Less active groups will drop in prominence in favor of new more active conversations.

### Networked Computing Environment

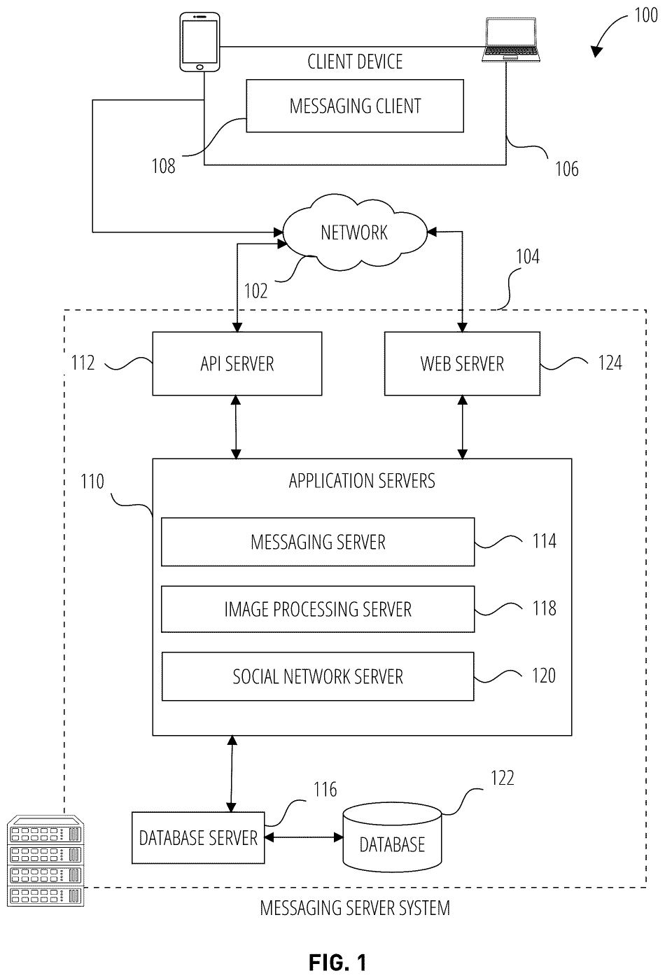

FIG. 1 is a block diagram showing an example messaging system 100 for exchanging data (e.g., messages and associated content) over a network. The messaging system 100 includes multiple instances of a client device 106, each of which hosts a number of applications, including a messaging client 108. Each messaging client 108 is communicatively coupled to other instances of the messaging client 108 and a messaging server system 104 via a network 102 (e.g., the internet).

A messaging client 108 is able to communicate and exchange data with another

messaging client 108 and with the messaging server system 104 via the network 102. The data exchanged between messaging client 108, and between a messaging client 108 and the messaging server system 104, includes functions (e.g., commands to invoke functions) as well as payload data (e.g., text, audio, video or other multimedia data).

The messaging server system 104 provides server-side functionality via the network 102 to a particular messaging client 108. While certain functions of the messaging system 100 are described herein as being performed by either a messaging client 108 or by the messaging server system 104, the location of certain functionality either within the messaging client 108 or the messaging server system 104 may be a design choice. For example, it may be technically preferable to initially deploy certain technology and functionality within the messaging server system 104 but to later migrate this technology and functionality to the messaging client 108 where a client device 106 has sufficient processing capacity.

The messaging server system 104 supports various services and operations that are provided to the messaging client 108. Such operations include transmitting data to, receiving data from, and processing data generated by the messaging client 108. This data may include message content, client device information, geolocation information, media augmentation and overlays, message content persistence conditions, social network information, and live event information, as examples. Data exchanges within the messaging system 100 are invoked and controlled through functions available via user interfaces (UIs) of the messaging client 108.

Turning now specifically to the messaging server system 104, an Application Program Interface (API) server 112 is coupled to, and provides a programmatic interface to, application servers 110. The application servers 110 are communicatively coupled to a database server 116, which facilitates access to a database 122 that stores data associated with messages processed by the application servers 110. Similarly, a web server 124 is coupled to the application servers 110, and provides web-based interfaces to the application servers 110. To this end, the web server 124 processes incoming network requests over the Hypertext Transfer Protocol (HTTP) and several other related protocols. In certain embodiments, the database 122 may include a decentralized database.

The Application Program Interface (API) server 112 receives and transmits message data (e.g., commands and message payloads) between the client device 106 and the application servers 110. Specifically, the Application Program Interface (API) server 112 provides a set of interfaces (e.g., routines and protocols) that can be called or queried by the messaging client 108 in order to invoke functionality of the application servers 110. The Application Program Interface (API) server 112 exposes various functions supported by the application servers 110, including account registration, login functionality, the sending of messages, via the application servers 110, from a particular messaging client 108 to another messaging client 108, the sending of media files (e.g., images or video) from a messaging client 108 to a messaging server 114, and for possible access by another messaging client 108, the settings of a collection of media data (e.g., story), the retrieval of a list of friends of a user of a client device 106, the retrieval of such collections, the retrieval of messages and content, the addition and deletion of entities (e.g., friends) to an entity graph (e.g., a social graph), the location of friends within a social graph, and opening an application event (e.g., relating to the messaging client 108).

The application servers 110 host a number of server applications and subsystems, including for example a messaging server 114, an image processing server 118, and a social network server 120. The messaging server 114 implements a number of message processing technologies and functions, particularly related to the aggregation and other processing of content (e.g., textual and multimedia content) included in messages received from multiple instances of the messaging client 108. As will be described in further detail, the text and media content from multiple sources may be aggregated into collections of content (e.g., called stories or galleries). These collections are then made available to the messaging client 108. Other processor and memory intensive processing of data may also be performed server-side by the messaging server 114, in view of the hardware requirements for such processing.

The application servers 110 also include an image processing server 118 that is dedicated to performing various image processing operations, typically with respect to images or video within the payload of a message sent from or received at the messaging server 114.

The social network server 120 supports various social networking functions and services and makes these functions and services available to the messaging server 114. Examples of functions and services supported by the social network server 120 include the identification of other users of the messaging system 100 with which a particular user has relationships or is “following,” and also the identification of other entities and interests of a particular user.

### System Architecture

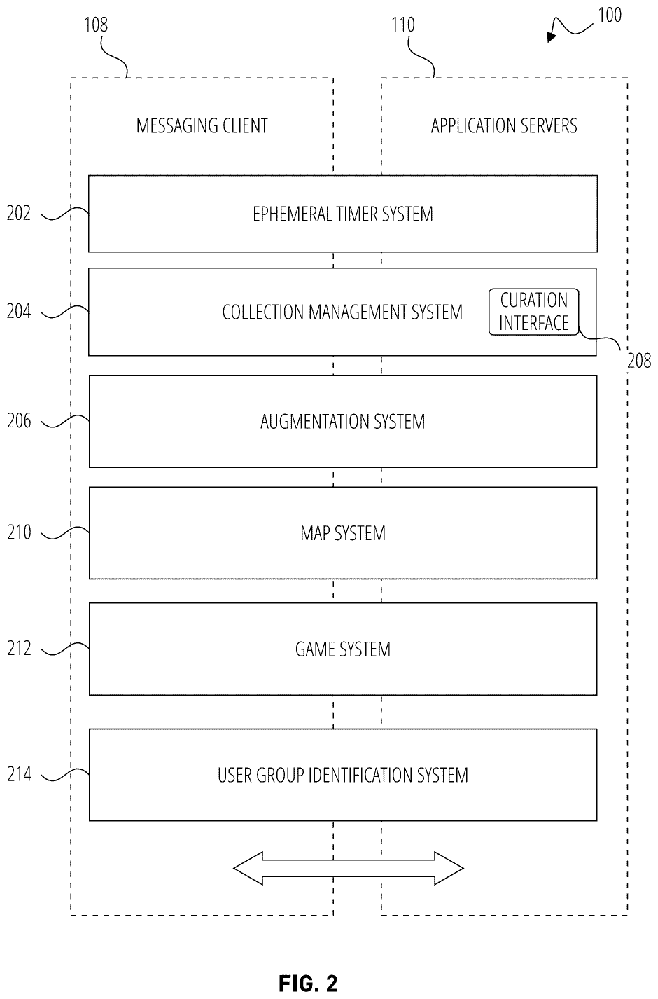

FIG. 2 is a block diagram illustrating further details regarding the messaging system 100, according to some examples. Specifically, the messaging system 100 is shown to comprise the messaging client 108 and the application servers 110. The messaging system 100 embodies a number of subsystems, which are supported on the client-side by the messaging client 108 and on the sever-side by the application servers 110. These subsystems include, for example, an ephemeral timer system 202, a collection management system 204, an augmentation system 206, a map system 210, a game system 212, and a User Group Identification System 214.

The ephemeral timer system 202 is responsible for enforcing the temporary or time-limited access to content by the messaging client 108 and the messaging server 114. The ephemeral timer system 202 incorporates a number of timers that, based on duration and display parameters associated with a message, or collection of messages (e.g., a story), selectively enable access (e.g., for presentation and display) to messages and associated content via the messaging client 108. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client 108.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 206 provides various functions that enable a user to augment (e.g., annotate or otherwise modify or edit) media content associated with a message. For example, the augmentation system 206 provides functions related to the generation and publishing of media overlays for messages processed by the messaging system 100. The augmentation system 206 operatively supplies a media overlay or augmentation (e.g., an image filter) to the messaging client 108 based on a geolocation of the client device 106. In another example, the augmentation system 206 operatively supplies a media overlay to the messaging client 108 based on other information, such as social network information of the user of the client device 106. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 106. For example, the media overlay may include text or image that can be overlaid on top of a photograph taken by the client device 106. In another example, the media overlay includes an identification of a location overlay (e.g., Venice beach), a name of a live event, or a name of a merchant overlay (e.g., Beach Coffee House). In another example, the augmentation system 206 uses the geolocation of the client device 106 to identify a media overlay that includes the name of a merchant at the geolocation of the client device 106. The media overlay may include other indicia associated with the merchant. The media overlays may be stored in the database 122 and accessed through the database server 116.

In some examples, the augmentation system 206 provides a user-based publication platform that enables users to select a geolocation on a map and upload content associated with the selected geolocation. The user may also specify circumstances under which a particular media overlay should be offered to other users. The augmentation system 206 generates a media overlay that includes the uploaded content and associates the uploaded content with the selected geolocation.

In other examples, the augmentation system 206 provides a merchant-based

publication platform that enables merchants to select a particular media overlay associated with a geolocation via a bidding process. For example, the augmentation system 206 associates the media overlay of the highest bidding merchant with a corresponding geolocation for a predefined amount of time.

The map system 210 provides various geographic location functions, and supports the presentation of map-based media content and messages by the messaging client 108. For example, the map system 210 enables the display of user icons or avatars on a map to indicate a current or past location of “friends” of a user, as well as media content (e.g., collections of messages including photographs and videos) generated by such friends, within the context of a map. For example, a message posted by a user to the messaging system 100 from a specific geographic location may be displayed within the context of a map at that particular location to “friends” of a specific user on a map interface of the messaging client 108. A user can furthermore share his or her location and status information (e.g., using an appropriate status avatar) with other users of the messaging system 100 via the messaging client 108, with this location and status information being similarly displayed within the context of a map interface of the messaging client 108 to selected users.

The game system 212 provides various gaming functions within the context of the messaging client 108. The messaging client 108 provides a game interface providing a list of available games that can be launched by a user within the context of the messaging client 108, and played with other users of the messaging system 100. The messaging system 100 further enables a particular user to invite other users to participate in the play of a specific game, by issuing invitations to such other users from the messaging client 108. The messaging client 108 also supports both the voice and text messaging (e.g., chats) within the context of gameplay, provides a leaderboard for the games, and also supports the provision of in-game rewards (e.g., coins and items).

The User Group Identification System 214 provides functions that may include: tracking messaging interactions initiated by a user to multiple groups over a period of time, including sent images, chats, videos and more; assigning scores to each group based on the tracked interactions, using numerical values and weights for different interaction types; selecting a subset of the top scoring groups to display in the messaging application interface as the user's Top Groups for that time period; showing Top Groups in a dedicated interface region, with graphical icons indicating their status; allowing customization of the icon associated with each Top Group; and ranking and selecting Top Groups based on interaction scores automatically, without requiring manual user configuration, according to certain example embodiments.

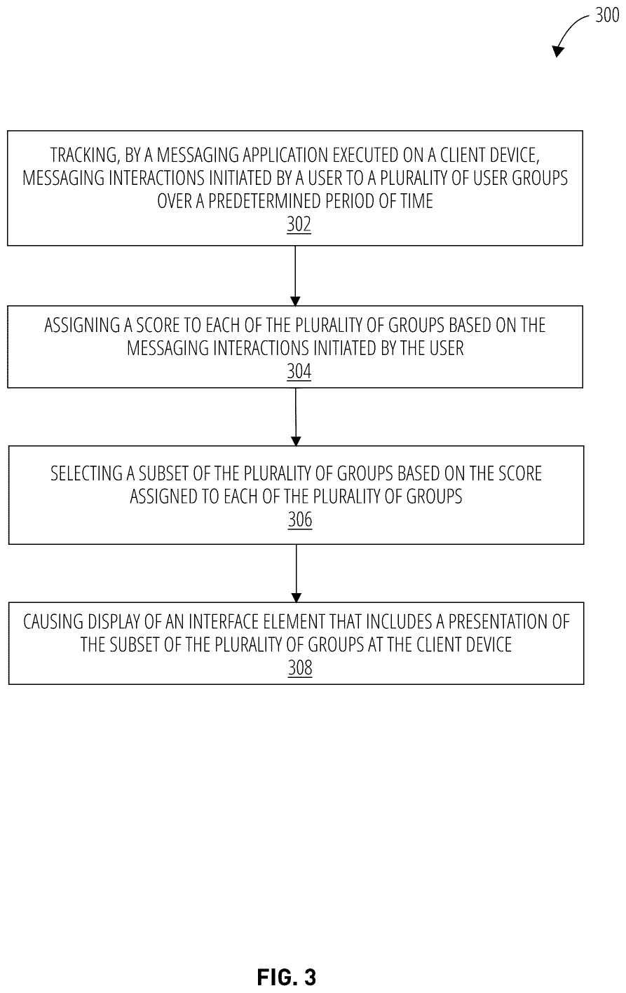

FIG. 3 is a flowchart illustrating operations of a User Group Identification System 214 in performing a method 300 for providing an interface to display user groups, in accordance with one embodiment. Operations of the method 300 may be performed by one or more subsystems of the messaging system 100 described above with respect to FIG. 2, such as the User Group Identification System 214. As shown in FIG. 3, the method 300 includes one or more operations 302, 304, 306, and 308.

In operation 302, the User Group Identification System 214 tracks messaging interactions initiated by a user of a client device 106 to a plurality of user groups over a predetermined time period, such as 7 days. The interactions can include sent chat messages, sent media like images/videos, or any other messages sent to the groups by the user. The interactions are tracked per group, to determine the user's engagement with each group.

In operation 304, the system assigns a score to each of the plurality of groups based on the tracked messaging interactions from operation 302. The scoring may involve assigning numerical values to each interaction based on attributes like interaction type, with different weights for chats, images, videos, etc. The numerical values are summed over the time period to generate a score for each group.

In operation 306, the messaging application selects a subset of the scored groups based on the assigned scores. This may involve ranking the groups by score and selecting the top X groups, where X is a predetermined number, like 3. The number of groups displayed can be limited to a subset of high-scoring groups.

In operation 308, the messaging application causes display of a user interface element at a client device 106, wherein the interface element presents the selected subset of groups from operation 306. This can include displaying the top groups in a dedicated region of the messaging interface, with graphical icons indicating their status as top groups. In some embodiments the user can provide inputs to assign graphical icons of their choice, such as emojis, bitmojis, or symbols, to be displayed next to each of their top groups in order to visually identify them.

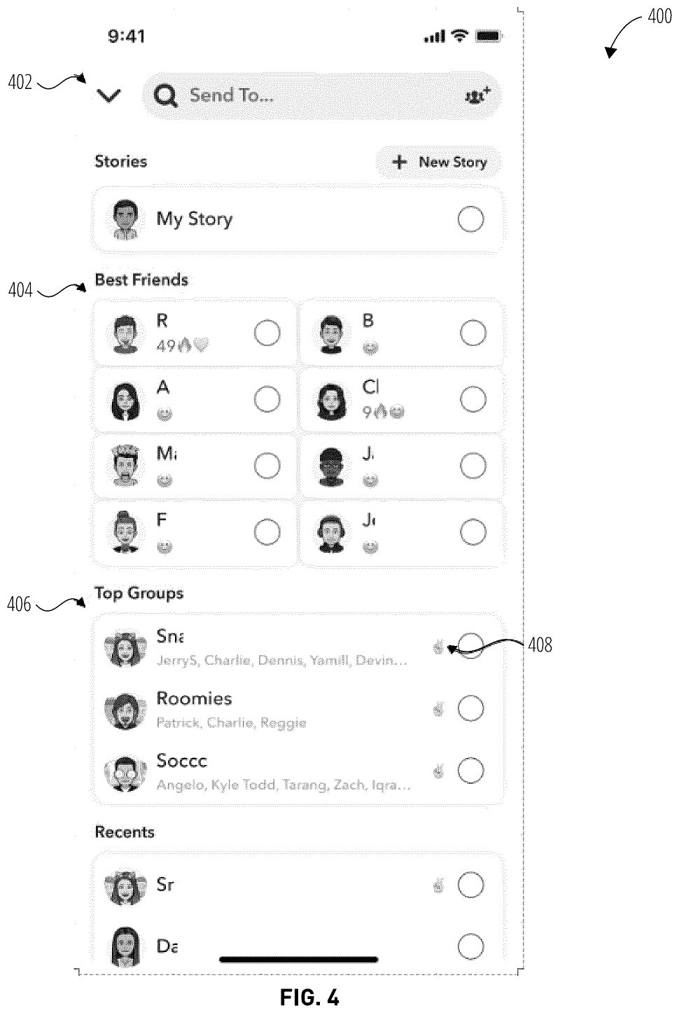

FIG. 4 is an interface diagram 400 depicting an interface to display user groups, in accordance with one embodiment. As seen in the interface diagram 400, an interface 402 may include a plurality of menu elements to display user identifiers associated with contacts of a user within a messaging application.

For example, the menu clement 404 may provide a region to display individual users in which a user of the client device client device 106 most frequently communicates with, while the menu element 406 may provide a region to display user groups in which the user of the client device 106 most frequently communicates with.

For example, in some embodiments as described above, the menu element 406 may include a presentation of the top-ranked groups for the user based on their recent one-way messaging activity, as determined by the scoring and ranking methods described in the method 300. In some embodiments, the top groups may show specialized icons 408 to indicate their status in the menu element 406.

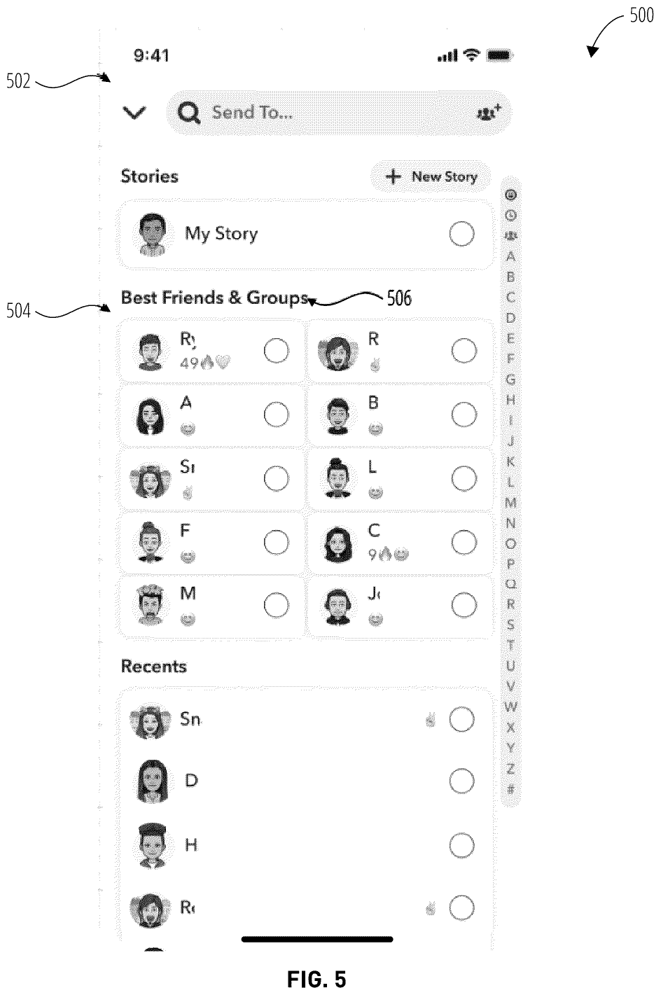

FIG. 5 is an interface diagram 500 depicting an interface to display user groups, in accordance with one embodiment. As seen in the interface diagram 500, an interface 402 may include a plurality of menu elements to display user identifiers associated with contacts of a user within a messaging application.

In some embodiments, and as depicted in the interface 502 of FIG. 5, user groups which receive a score above a certain threshold value may be presented among individual users shown in a “Best Friends” section (i.e., the menu element 504). Upon determining that one or more user groups receive a score above a certain threshold, the system may modify an identifier associated with the menu element 504 to reflect that the menu element 504 includes a display of individual identifiers as well as group identifiers. Similarly, if no user groups are identified with scores above the threshold, then the identifier 506 may be updated to reflect that the menu clement 504 includes only individual users (as seen in FIG. 4).

In some embodiments, the threshold may be defined based on scores associated with the individual users depicted within the menu element 504.

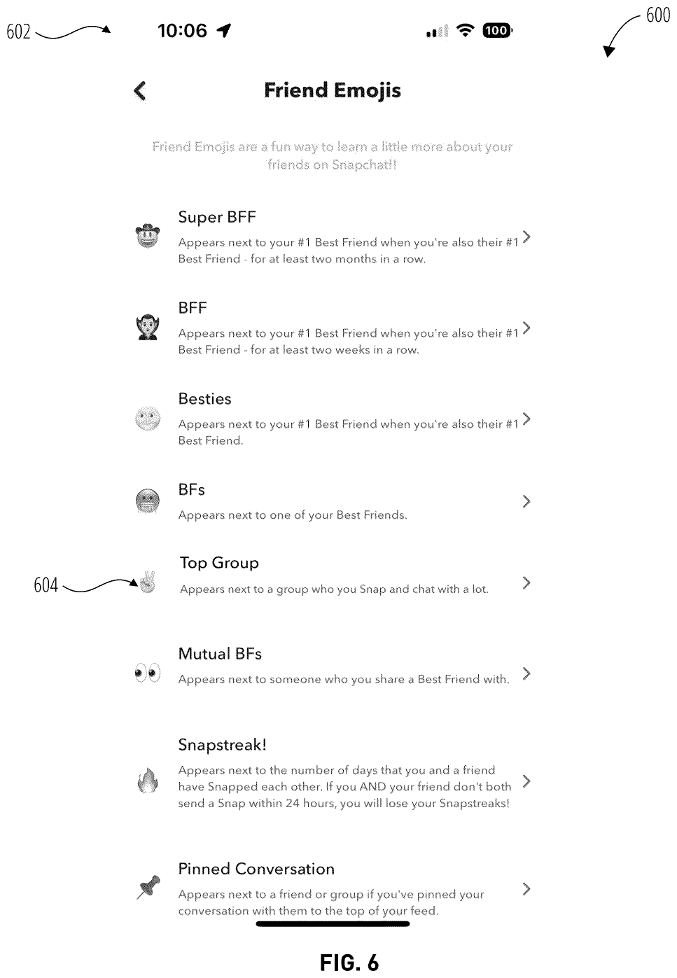

FIG. 6 is an interface diagram 600 depicting an interface to select graphical icons, in accordance with one embodiment. As seen in the interface diagram 600, an interface 602 may include a listing of a plurality of attributes that may be associated with users or users groups within a messaging environment. For example, the attributes may include indications of a status associated with users or user groups, such as a user status as “Best Friend,” or “Top Group.” The status of a given user or user group may be determined based on messaging interactions between users within the messaging application.

In some embodiments, a user of the client device 106 may provide inputs to associate graphical icons with each attribute among the list of attributes presented within the interface 602. By doing so, the selected icon may appear proximate to users or user groups which include the corresponding attribute or status. As an illustrative example, by assigning the graphical icon 604 to the “Top Group” attribute, user groups that are selected for display in the “Top Group” menu element may be presented with the graphical icon 604.

### Machine Architecture

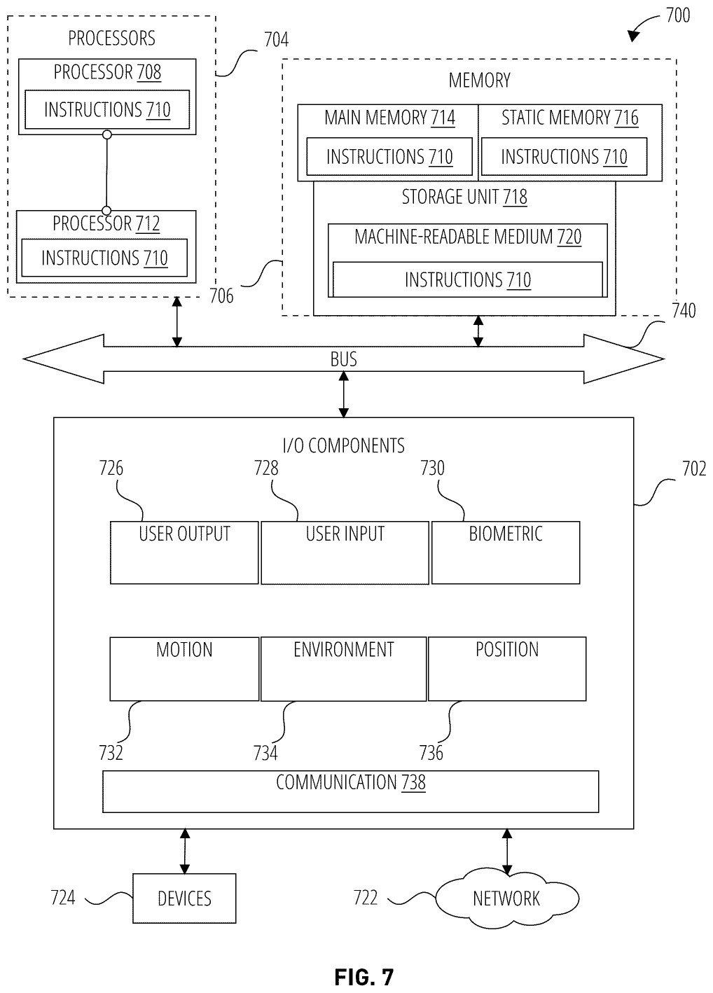

FIG. 7 is a diagrammatic representation of the machine 700 within which instructions 710 (e.g., software, a program, an application, an applet, an app, or other executable code) for causing the machine 700 to perform any one or more of the methodologies discussed herein may be executed. For example, the instructions 710 may cause the machine 700 to execute any one or more of the methods described herein. The instructions 710 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 710, sequentially or otherwise, that specify actions to be taken by the machine 700. Further, while only a single machine 700 is illustrated, the term “machine” shall also be taken to include a collection of machines that individually or jointly execute the instructions 710 to perform any one or more of the methodologies discussed herein. The machine 700, for example, may comprise the client device 106 or any one of a number of server devices forming part of the messaging server system 104. In some examples, the machine 700 may also comprise both client and server systems, with certain operations of a particular method or algorithm being performed on the server-side and with certain operations of the particular method or algorithm being performed on the client-side.

The machine 700 may include processors 704, memory 706, and input/output I/O components 638, which may be configured to communicate with each other via a bus 740. In an example, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 708 and a processor 712 that execute the instructions 710. The term “processor” is intended to include multi-core processors that may comprise two or more independent processors (sometimes referred to as “cores”) that may execute instructions contemporaneously. Although FIG. 7 shows multiple processors 704, the machine 700 may include a single processor with a single-core, a single processor with multiple cores (e.g., a multi-core processor), multiple processors with a single core, multiple processors with multiples cores, or any combination thereof.

The memory 706 includes a main memory 714, a static memory 716, and a storage unit 718, both accessible to the processors 704 via the bus 740. The main memory 706, the static memory 716, and storage unit 718 store the instructions 710 embodying any one or more of the methodologies or functions described herein. The instructions 710 may also reside, completely or partially, within the main memory 714, within the static memory 716, within machine-readable medium 720 within the storage unit 718, within at least one of the processors 704 (e.g., within the Processor's cache memory), or any suitable combination thereof, during execution thereof by the machine 700.

The I/O components 702 may include a wide variety of components to receive input, provide output, produce output, transmit information, exchange information, capture measurements, and so on. The specific I/O components 702 that are included in a particular machine will depend on the type of machine. For example, portable machines such as mobile phones may include a touch input device or other such input mechanisms, while a headless server machine will likely not include such a touch input device. It will be appreciated that the I/O components 702 may include many other components that are not shown in FIG. 7. In various examples, the I/O components 702 may include user output components 726 and user input components 728. The user output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 702 may include biometric components 730, motion components 732, environmental components 734, or position components 736, among a wide array of other components. For example, the biometric components 730 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 732 include acceleration sensor components (e.g., accelerometer), gravitation sensor components, rotation sensor components (e.g., gyroscope).

The environmental components 734 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 106 may have a camera system comprising, for example, front cameras on a front surface of the client device 106 and rear cameras on a rear surface of the client device 106. The front cameras may, for example, be used to capture still images and video of a user of the client device 106 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 106 may also include a 360° camera for capturing 360° photographs and videos.

Further, the camera system of a client device 106 may include dual rear cameras (e.g., a primary camera as well as a depth-sensing camera), or even triple, quad or penta rear camera configurations on the front and rear sides of the client device 106. These multiple cameras systems may include a wide camera, an ultra-wide camera, a telephoto camera, a macro camera and a depth sensor, for example.

The position components 736 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 702 further include communication components 738 operable to couple the machine 700 to a network 722 or devices 724 via respective coupling or connections. For example, the communication components 738 may include a network interface Component or another suitable device to interface with the network 722. In further examples, the communication components 738 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 724 may be another machine or any of a wide variety of peripheral devices (e.g., a peripheral device coupled via a USB).

Moreover, the communication components 738 may detect identifiers or include components operable to detect identifiers. For example, the communication components 738 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 738, such as location via Internet Protocol (IP) geolocation, location via Wi-Fi® signal triangulation, location via detecting an NFC beacon signal that may indicate a particular location, and so forth.

The various memories (e.g., main memory 714, static memory 716, and memory of the processors 704) and storage unit 718 may store one or more sets of instructions and data structures (e.g., software) embodying or used by any one or more of the methodologies or functions described herein. These instructions (e.g., the instructions 710), when executed by processors 704, cause various operations to implement the disclosed examples.

The instructions 710 may be transmitted or received over the network 722, using a transmission medium, via a network interface device (e.g., a network interface component included in the communication components 738) and using any one of several well-known transfer protocols (e.g., hypertext transfer protocol (HTTP)). Similarly, the instructions 710 may be transmitted or received using a transmission medium via a coupling (e.g., a peer-to-peer coupling) to the devices 724.

### Software Architecture

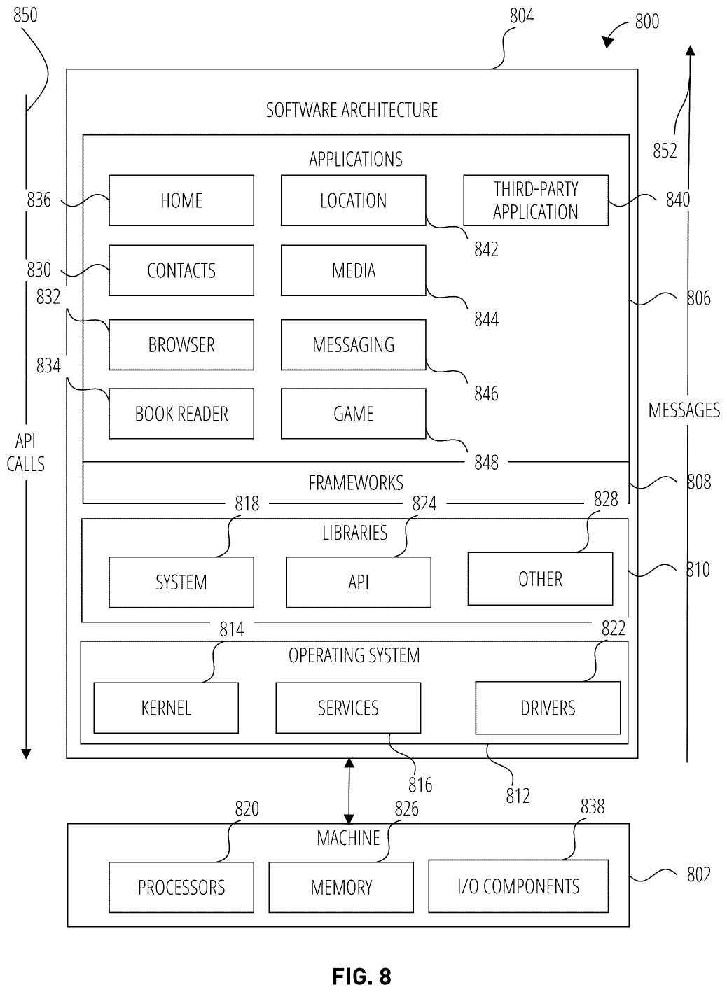

FIG. 8 is a block diagram 800 illustrating a software architecture 804, which can be installed on any one or more of the devices described herein. The software architecture 804 is supported by hardware such as a machine 802 that includes processors 820, memory 826, and I/O components 838. In this example, the software architecture 804 can be conceptualized as a stack of layers, where each layer provides a particular functionality. The software architecture 804 includes layers such as an operating system 812, libraries 810, frameworks 808, and applications 806. Operationally, the applications 806 invoke API calls 850 through the software stack and receive messages 852 in response to the API calls 850.

The operating system 812 manages hardware resources and provides common services. The operating system 812 includes, for example, a kernel 814, services 816, and drivers 822. The kernel 814 acts as an abstraction layer between the hardware and the other software layers. For example, the kernel 814 provides memory management, processor management (e.g., scheduling), component management, networking, and security settings, among other functionality. The services 816 can provide other common services for the other software layers. The drivers 822 are responsible for controlling or interfacing with the underlying hardware. For instance, the drivers 822 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 810 provide a common low-level infrastructure used by the applications 806. The libraries 810 can include system libraries 818 (e.g., C standard library) that provide functions such as memory allocation functions, string manipulation functions, mathematic functions, and the like. In addition, the libraries 810 can include API libraries 824 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC),

Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 810 can also include a wide variety of other libraries 828 to provide many other APIs to the applications 806.

The frameworks 808 provide a common high-level infrastructure that is used by the applications 806. For example, the frameworks 808 provide various graphical user interface (GUI) functions, high-level resource management, and high-level location services. The frameworks 808 can provide a broad spectrum of other APIs that can be used by the applications 806, some of which may be specific to a particular operating system or platform.

In an example, the applications 806 may include a home application 836, a contacts application 830, a browser application 832, a book reader application 834, a location application 842, a media application 844, a messaging application 846, a game application 848, and a broad assortment of other applications such as a third-party application 840. The applications 806 are programs that execute functions defined in the programs. Various programming languages can be employed to create one or more of the applications 806, structured in a variety of manners, such as object-oriented programming languages (e.g., Objective-C, Java, or C++) or procedural programming languages (e.g., C or assembly language). In a specific example, the third-party application 840 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 840 can invoke the API calls 850 provided by the operating system 812 to facilitate functionality described herein.

### Processing Components

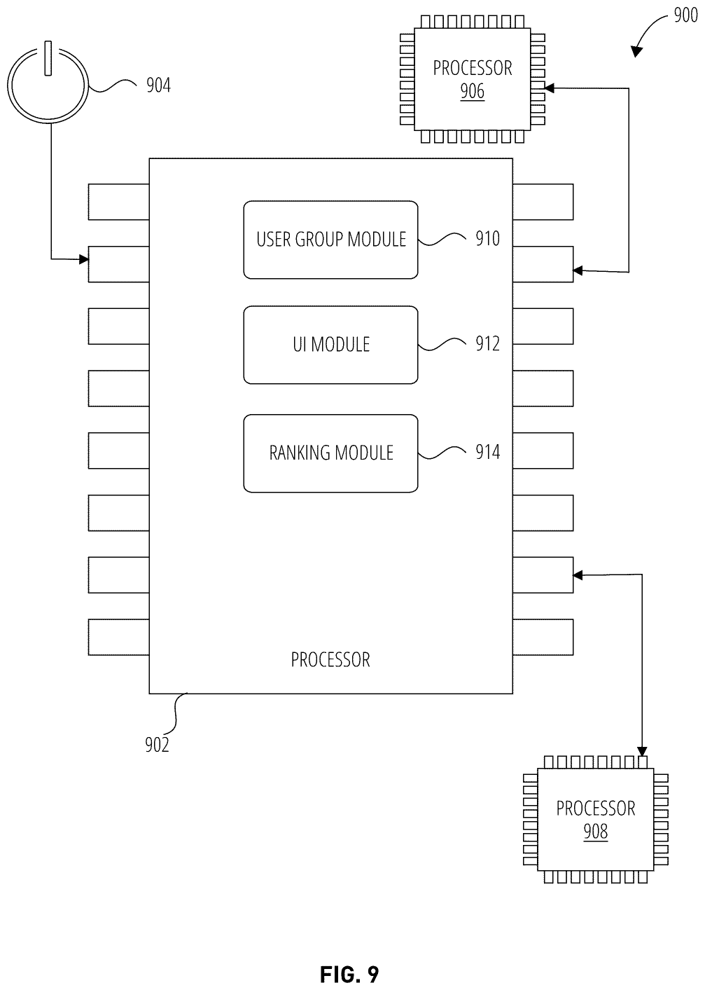

Turning now to FIG. 9, there is shown a diagrammatic representation of a processing environment 900, which includes a processor 902, a processor 906, and a processor 908 (e.g., a GPU, CPU or combination thereof).

The processor 902 is shown to be coupled to a power source 904, and to include (either permanently configured or temporarily instantiated) modules, namely a user group module 910, a UI module 712, and a ranking module 914, operationally configured to perform operations as discussed in the method 300 of FIG. 3, and the interface flow diagram 400 of FIG. 4, in accordance with embodiments discussed herein.

### EXAMPLES

Example 1 is a method comprising: tracking, by a messaging application executed on a client device, messaging interactions initiated by a user to a plurality of user groups over a predetermined period of time; assigning a score to each of the plurality of groups based on the messaging interactions initiated by the user; selecting a subset of the plurality of groups based on the score assigned to each of the plurality of groups; and causing display of an interface element that includes a presentation of the subset of the plurality of groups at the client device.

In Example 2, the subject matter of Example 1, wherein the messaging interactions comprise at least one of: a sent image; a sent chat message; and a sent video message.

In Example 3, the subject matter of Example 1 or 2, wherein assigning the score comprises: assigning a numerical value to each messaging interaction initiated by the user based on an attribute of each messaging interaction; summing the numerical values assigned to each messaging interaction for each of the plurality of groups over the predetermined time period to generate the score.

In Example 4, the subject matter of any one of Examples 1-3, wherein the attribute includes a type of interaction.

In Example 5, the subject matter of any one of Examples 1-4, wherein the selecting the subset of the plurality of groups includes: determining a ranking of the plurality of groups based on the score assigned to each of the plurality of groups; and selecting the subset of the plurality of groups based on the ranking.

In Example 6, the subject matter of any one of Examples 1-5, wherein the presentation of the subset of the plurality of user groups comprises a display of one or more group identifiers associated with the subset of the plurality of user groups, wherein the one or more group identifiers include a graphical icon that indicate a status of the subset of the plurality of user groups.

In Example 7, the subject matter of any one of Examples 1-6, further comprising: receiving an input that assigns the graphical icon to the status.

Example 8 is a system comprising: one or more processors; and a memory comprising instructions which, when executed by the one or more processors, cause the one or more processors to perform operations comprising: tracking, by a messaging application executed on a client device, messaging interactions initiated by a user to a plurality of user groups over a predetermined period of time; assigning a score to each of the plurality of groups based on the messaging interactions initiated by the user; selecting a subset of the plurality of groups based on the score assigned to each of the plurality of groups; and causing display of an interface clement that includes a presentation of the subset of the plurality of groups at the client device.

In Example 9, the subject matter of Example 8, wherein the messaging interactions comprise at least one of: a sent image; a sent chat message; and a sent video message.

In Example 10, the subject matter of Example 8 or 9, wherein assigning the score comprises: assigning a numerical value to each messaging interaction initiated by the user based on an attribute of each messaging interaction; summing the numerical values assigned to each messaging interaction for each of the plurality of groups over the predetermined time period to generate the score.

In Example 11, the subject matter of any one of Examples 8-10, wherein the attribute includes a type of interaction.

In Example 12, the subject matter of any one of Examples 8-11, wherein the selecting the subset of the plurality of groups includes: determining a ranking of the plurality of groups based on the score assigned to each of the plurality of groups; and selecting the subset of the plurality of groups based on the ranking.

In Example 13, the subject matter of any one of Examples 8-12, wherein the presentation of the subset of the plurality of user groups comprises a display of one or more group identifiers associated with the subset of the plurality of user groups, wherein the one or more group identifiers include a graphical icon that indicate a status of the subset of the plurality of user groups.

In Example 14, the subject matter of any one of Examples 8-13, further comprising: receiving an input that assigns the graphical icon to the status.

Example 15 is a machine-readable storage medium comprising instructions that, when executed by one or more processors of a machine, cause the machine to perform operations comprising: tracking, by a messaging application executed on a client device, messaging interactions initiated by a user to a plurality of user groups over a predetermined period of time; assigning a score to each of the plurality of groups based on the messaging interactions initiated by the user; selecting a subset of the plurality of groups based on the score assigned to each of the plurality of groups; and causing display of an interface element that includes a presentation of the subset of the plurality of groups at the client device.

In Example 16, the subject matter of Example 15, wherein the messaging interactions comprise at least one of: a sent image; a sent chat message; and a sent video message.

In Example 17, the subject matter of Example 15 or 16, wherein assigning the score comprises: assigning a numerical value to each messaging interaction initiated by the user based on an attribute of each messaging interaction; summing the numerical values assigned to each messaging interaction for each of the plurality of groups over the predetermined time period to generate the score.

In Example 18, the subject matter of any one of Examples 15-17, wherein the attribute includes a type of interaction.

In Example 19, the subject matter of any one of Examples 15-18, wherein the selecting the subset of the plurality of groups includes: determining a ranking of the plurality of groups based on the score assigned to each of the plurality of groups; and selecting the subset of the plurality of groups based on the ranking.

In Example 20, the subject matter of any one of Examples 15-19, wherein the

presentation of the subset of the plurality of user groups comprises a display of one or more group identifiers associated with the subset of the plurality of user groups, wherein the one or more group identifiers include a graphical icon that indicate a status of the subset of the plurality of user groups.

### GLOSSARY

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
tracking, by a messaging application executed on a client device, messaging interactions initiated by a user to a plurality of user groups over a predetermined period of time;
assigning a score to each of the plurality of groups based on the messaging interactions initiated by the user;
selecting a subset of the plurality of groups based on the score assigned to each of the plurality of groups; and
causing display of an interface element that includes a presentation of the subset of the plurality of groups at the client device.

2. The method of claim 1, wherein the messaging interactions comprise at least one of:
a sent image;
a sent chat message; and
a sent video message.

3. The method of claim 1, wherein assigning the score comprises:
assigning a numerical value to each messaging interaction initiated by the user based on an attribute of each messaging interaction;
summing the numerical values assigned to each messaging interaction for each of the plurality of groups over the predetermined time period to generate the score.

4. The method of claim 3, wherein the attribute includes a type of interaction.

5. The method of claim 1, wherein the selecting the subset of the plurality of groups includes:
determining a ranking of the plurality of groups based on the score assigned to each of the plurality of groups; and
selecting the subset of the plurality of groups based on the ranking.

6. The method of claim 1, wherein the presentation of the subset of the plurality of user groups comprises a display of one or more group identifiers associated with the subset of the plurality of user groups, wherein the one or more group identifiers include a graphical icon that indicate a status of the subset of the plurality of user groups.

7. The method of claim 1, further comprising:
receiving an input that assigns the graphical icon to the status.

8. A system comprising:
one or more processors; and
a memory comprising instructions which, when executed by the one or more processors, cause the one or more processors to perform operations comprising:
tracking, by a messaging application executed on a client device, messaging interactions initiated by a user to a plurality of user groups over a predetermined period of time;
assigning a score to each of the plurality of groups based on the messaging interactions initiated by the user;
selecting a subset of the plurality of groups based on the score assigned to each of the plurality of groups; and
causing display of an interface element that includes a presentation of the subset of the plurality of groups at the client device.

9. The system of claim 8, wherein the messaging interactions comprise at least one of:
a sent image;
a sent chat message; and
a sent video message.

10. The system of claim 8, wherein assigning the score comprises:
assigning a numerical value to each messaging interaction initiated by the user based on an attribute of each messaging interaction;
summing the numerical values assigned to each messaging interaction for each of the plurality of groups over the predetermined time period to generate the score.

11. The system of claim 10, wherein the attribute includes a type of interaction.

12. The system of claim 8, wherein the selecting the subset of the plurality of groups includes:
determining a ranking of the plurality of groups based on the score assigned to each of the plurality of groups; and
selecting the subset of the plurality of groups based on the ranking.

13. The system of claim 8, wherein the presentation of the subset of the plurality of user groups comprises a display of one or more group identifiers associated with the subset of the plurality of user groups, wherein the one or more group identifiers include a graphical icon that indicate a status of the subset of the plurality of user groups.

14. The system of claim 8, further comprising:
receiving an input that assigns the graphical icon to the status.

15. A machine-readable storage medium comprising instructions that, when executed by one or more processors of a machine, cause the machine to perform operations comprising:
tracking, by a messaging application executed on a client device, messaging interactions initiated by a user to a plurality of user groups over a predetermined period of time;
assigning a score to each of the plurality of groups based on the messaging interactions initiated by the user;
selecting a subset of the plurality of groups based on the score assigned to each of the plurality of groups; and
causing display of an interface element that includes a presentation of the subset of the plurality of groups at the client device.

16. The machine-readable storage medium of claim 15, wherein the messaging interactions comprise at least one of:
a sent image;
a sent chat message; and
a sent video message.

17. The machine-readable storage medium of claim 15, wherein assigning the score comprises:
assigning a numerical value to each messaging interaction initiated by the user based on an attribute of each messaging interaction;
summing the numerical values assigned to each messaging interaction for each of the plurality of groups over the predetermined time period to generate the score.

18. The machine-readable storage medium of claim 17, wherein the attribute includes a type of interaction.

19. The machine-readable storage medium of claim 15, wherein the selecting the subset of the plurality of groups includes:
determining a ranking of the plurality of groups based on the score assigned to each of the plurality of groups; and
selecting the subset of the plurality of groups based on the ranking.

20. The machine-readable storage medium of claim 15, wherein the presentation of the subset of the plurality of user groups comprises a display of one or more group identifiers associated with the subset of the plurality of user groups, wherein the one or more group identifiers include a graphical icon that indicate a status of the subset of the plurality of user groups.
